(19) United States
(12) Patent Application Publication
(10) Pub. No.: US 2003/0145471 A1
(43) Pub. Date: Aug. 7, 2003

(54) Rice scoop

(76) Inventors: Masato Sano, Kato-gun (JP); Masahiro Koyama, Sanda-shi (JP); Osamu Miyazaki, Kakogawa-shi (JP)

Correspondence Address: PEARNE & GORDON LLP, 526 SUPERIOR AVENUE EAST, SUITE 1200, CLEVELAND, OH, 44114-1484, US

(21) Appl. No.: 10/296,302

(22) PCT Filed: Jun. 13, 2001
(86) PCT No.: PCT/JP01/05031

(30) Foreign Application Priority Data
Jun. 14, 2000 (JP) 2000-177949

(51) Int. Cl. A47J 43/28

(52) U.S. Cl. 30/324

(57) ABSTRACT

It is an object of the invention to prevent a rice grain from sticking to a scooping portion of a rice scoop. More specifically, in the invention, a large projection (13) and a small projection (14) are provided on a surface, a side surface and a rear surface of a scooping portion (12) of the rice scoop. Consequently, a contact area with a rice grain can be reduced, a separating property can be enhanced and rice can be prevented from sticking.

### TECHNICAL FIELD

The present invention relates to a rice scoop for dishing up rice in a general household or for business use.

### BACKGROUND ART

A conventional rice scoop has a gripping portion 31 and a scooping portion 32 for scooping rice and is constituted by a polypropylene resin to be a material as shown in FIG. 3.

However, in the case in which the rice is to be scooped by means of the rice scoop having the structure described above, a glue-like thin film is apt to stick to the scooping portion, appearance is deteriorated, and furthermore, an unsanitary condition is brought and a work for removing the rice from the scooping portion takes a great deal of time and labor.

The invention has been made to solve the problem and has an object to provide a rice scoop capable of preventing a rice grain or a glue-like thin film from sticking.

### DISCLOSURE OF THE INVENTION

In order to solve the problem, in the invention, the surface, side surface and rear surface parts of the scooping portion have at least three projections taking different shapes.

In the invention, three or more projections having different shapes are provided. Therefore, more projections can be provided under a certain limited area and the contact area of the body base face of the scooping portion for scooping rice and a rice grain is reduced to cause the rice grain or a glue-like thin film to stick with difficulty.

### BRIEF DESCRIPTION OF THE DRAWINGS

FIG. 1 is a view showing the state of arrangement of the projection of a rice scoop according to an example of the invention;

FIG. 2 is a view showing the state of arrangement of anther projection of the rice scoop; and

FIG. 3 is a plan view showing a conventional rice scoop.

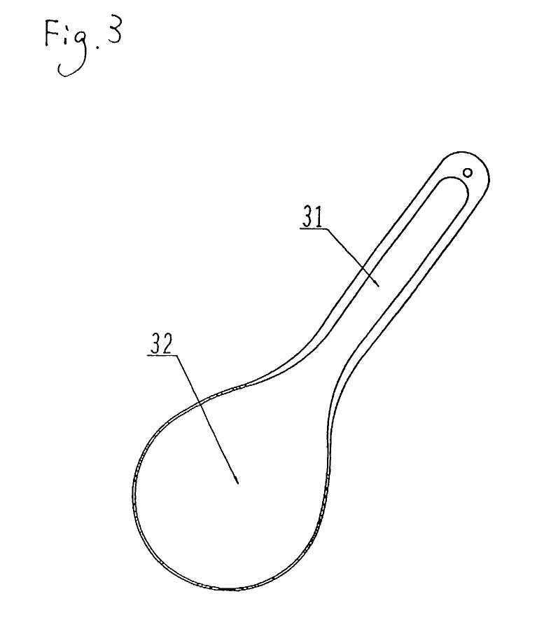

### BEST MODE OF CARRYING OUT THE INVENTION

In the invention, (1) there are provided a gripping portion and a scooping portion for scooping rice, and at least three kinds of different projections are provided on a surface, a side surface part and a rear surface of the scooping portion. Consequently, a contact area with a rice grain is reduced and the rice grain or a glue-like thin film sticks with difficulty.

In the invention, (2) a projection has a larger size on a center of the scooping portion and a smaller size on a peripheral part. Consequently, the number of the projections provided over the whole surface of the scooping portion can be increased as much as possible. Consequently, there is an advantage that rice does not stick to the peripheral part, a sanitary condition can be brought and production can easily be carried out.

In the invention, (3) peripheral and side surface parts of the scooping portion are processed with granulation. Consequently, there is an effect that the contact area of the rice and the rice scoop is increased on the peripheral part and the rice sticks with more difficulty when the rice is to be scooped. In the production using injection molding, moreover, there is also an advantage that the structure of a metal mold can be simplified, resulting in easy production.

### EXAMPLE

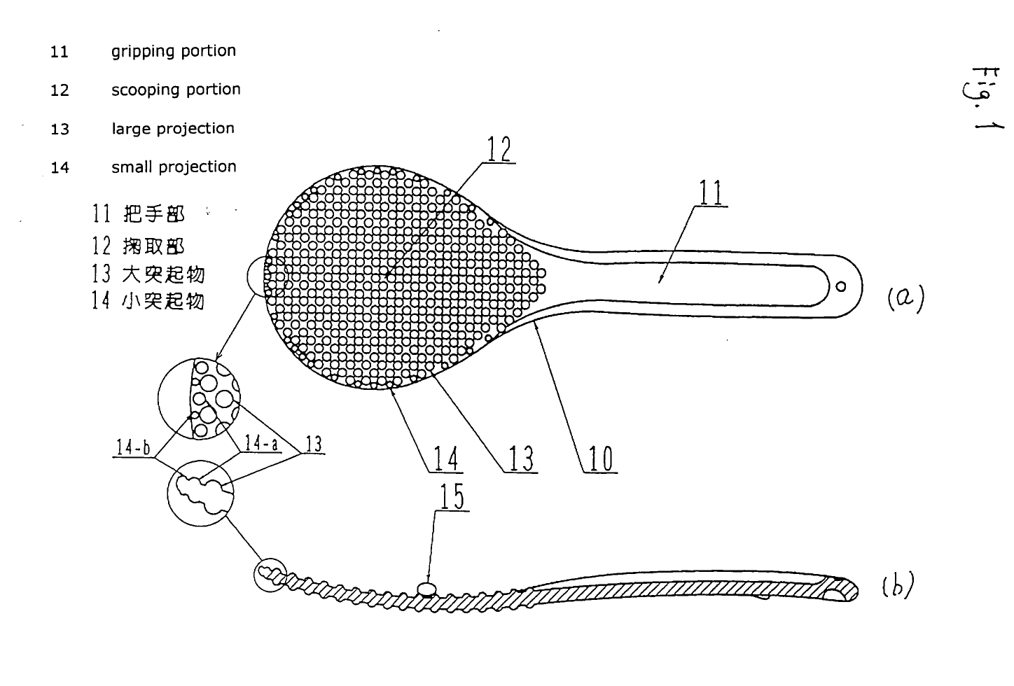

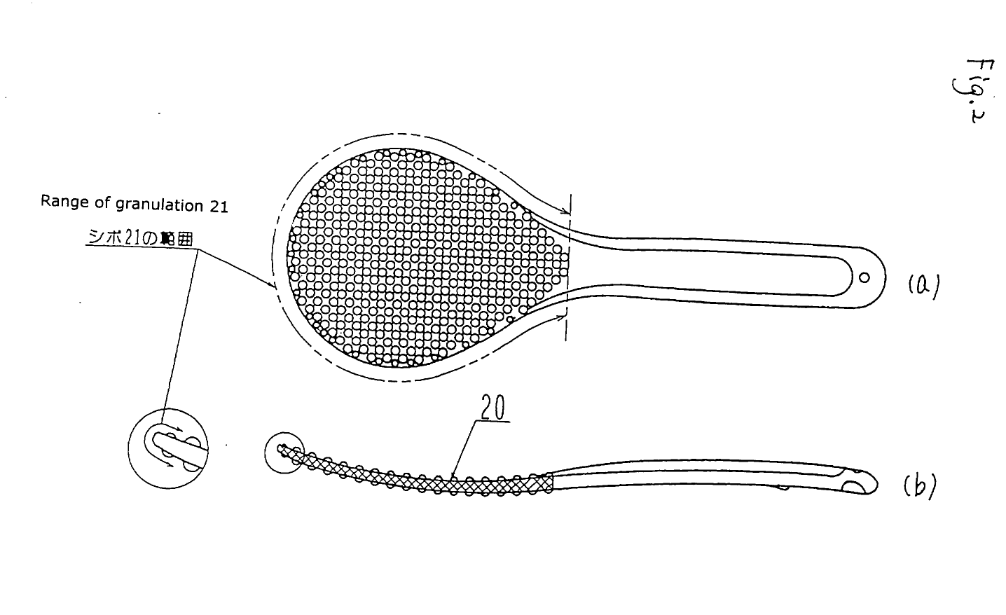

An example of the invention will be described below with reference to FIGS. 1 and 2.

In FIG. 1, a rice scoop 10 includes a gripping portion 11 to be gripped by a hand and a scooping portion 12 widened from the tip of the gripping portion 11 which are formed integrally. The scooping portion 12 serves to scoop rice. The scooping portion 12 is a plane curved from the tip of the gripping portion 11.

The scooping portion 12 has a thickness of approximately 2 mm and the surface of the scooping portion 12 is provided with a large projection 13 and a small projection 14, and the large projection 13 takes a hemispherical shape having a diameter of 2.8 mm and a height of 1.2 mm, for example. Moreover, the small projection 14 takes a hemispherical shape having a diameter of 1.9 mm and a height of 0.7 mm, for example. The large projection 13 is aligned over almost the whole surface part of the scooping portion 12 and the small projection 14 is provided in the surface part of the scooping portion 12 in which the large projection 13 cannot be provided at all in respect of a structure.

The rear surface of the scooping portion 12 also takes the same shape as that of the surface part and is provided with the large projection 13 and the small projection 14. By such arrangement, the number of projections provided over the whole surface of the scooping portion can be increased as much as possible. Moreover, it is apparent that a large number of projections can be provided in the surface part of the scooping portion 12 by changing the diameter and height of the shape of the small projection. By such a structure, there is also an advantage that the contact area of the rice and the rice scoop can be reduced, a rice grain 15 does not stick to a peripheral part, a sanitary condition can be brought and production can easily be carried out.

In FIG. 2, a granulation 21 is provided in the side surface part of the scooping portion 20. The outer peripheral side surface part of the scooping portion 20 is an erected side wall surface having a thickness of 2 mm and cannot be provided with a projection. Although an area is small, a rice grain or a glue-like thin film sticks to this portion. In order to satisfy the foregoing, the granulation 21 is carried out over the side surface part of the scooping portion 20 so that a contact area can be reduced and a separating property can be enhanced in a third example. In such an example, moreover, there is also an advantage that a projection does not need to be provided by a metal mold division on a side surface, for example, and the structure of the metal mold can be simplified in production using molding injection, resulting in easy production.

### INDUSTRIAL AVAILABILITY

As described above, according to the invention, a rice grain does not stick, appearance can be enhanced, and washing can easily be carried out after use.

1. A rice scoop comprising a gripping portion and a scooping portion for scooping rice, wherein at least three kinds of projections having different shapes are provided on a surface, a side surface part and a rear surface of the scooping portion.

2. The rice scoop according to claim 1, wherein the projection has a larger size on a center of the scooping portion and a smaller size on a peripheral part.

3. The rice scoop according to claim 1, wherein a peripheral part and the side surface part of the scoop portion are processed with granulation.

4. A rice scoop comprising:
a gripping portion;
a scooping portion for scooping rice; and
a projection portion including a plurality of large projections, a plurality of medium projections which are smaller than the large projections and a plurality of small projections which are smaller than the medium projections, and provided on a surface and a rear surface of the scooping portion.

5. The rice scoop according to claim 4, wherein the large projection is provided in a central part of the scooping portion, the medium projection is provided on a peripheral part of the scooping portion on an outside of the central part, and the small projection is provided on a peripheral part of the peripheral part of the scooping portion provided with the medium projection.

6. The rice scoop according to claim 4, wherein a peripheral part and a side surface part of the scooping portion are processed with granulation.
